(19) United States
(12) Patent Application Publication
(10) Pub. No.: US 2023/0252827 A1
(43) Pub. Date: Aug. 10, 2023

(54) CLOUD DIAGNOSIS SERVICE SYSTEM AND VEHICLE DETECTION METHOD

(71) Applicant: SUITAI ELECTRONIC LTD., New Taipei City (TW)

(72) Inventors: JAMES DARREL COSPER, New Taipei City (TW); JAMES RAYMOND COSPER, New Taipei City (TW)

(21) Appl. No.: 17/840,555

(22) Filed: Jun. 14, 2022

(30) Foreign Application Priority Data
Feb. 7, 2022 (TW) 111104238

(51) Int. Cl. G07C 5/00; B60W 20/20

(52) U.S. Cl. CPC G07C 5/008; B60W 20/20; B60W 2300/36; B60W 2510/0657

(57) ABSTRACT

A cloud diagnosis service system and a vehicle detection method are provided. The vehicle detection method includes the following steps: providing a vehicle detection unit, in which the vehicle detection unit is configured to be connected to an electric bicycle and a server; providing a vehicle detection signal to the electric bicycle by the vehicle detection unit; providing, according to the vehicle detection signal, a plurality of state values of a vehicle controller, a torque sensor, a motor unit, a battery unit, and a connection wire group to the vehicle detection unit by the vehicle controller of the electric bicycle; and providing, according to the plurality of state values of the vehicle controller, the torque sensor, the motor unit, the battery unit, and the connection wire group, a vehicle detection report by the vehicle detection unit or the server.

### CROSS-REFERENCE TO RELATED PATENT APPLICATION

This application claims the benefit of priority to Taiwan Patent Application No. 111104238, filed on Feb. 7, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a cloud diagnosis service system and a vehicle detection method, and more particularly to a cloud diagnosis service system and a vehicle detection method that have low cost.

### BACKGROUND OF THE DISCLOSURE

Electric vehicles have become more and more popular, but vehicle diagnostic services or vehicle maintenance services still need to be provided by manufacturers. In response to an ever-expanding range of commercial products, the cost of providing the vehicle diagnostic services or the vehicle maintenance services has also increased.

### SUMMARY OF THE DISCLOSURE

In response to the above-referenced technical inadequacies, the present disclosure provides a cloud diagnosis service system and a vehicle detection method.

In one aspect, the present disclosure provides a cloud diagnosis service system. The cloud diagnosis service system is adapted for an electric bicycle. The electric bicycle includes a vehicle controller, a torque sensor, a motor unit, a battery unit, and a connection wire group. The vehicle controller is connected to the torque sensor, the battery unit, and the motor unit through the connection wire group. The cloud diagnosis service system includes a server and a vehicle detection unit. The vehicle detection unit is connected to the electric bicycle and the server. The vehicle detection unit downloads a first detection program from the server. The vehicle detection unit provides a vehicle detection signal to the electric bicycle. The vehicle controller provides a plurality of state values of the vehicle controller, the torque sensor, the motor unit, the battery unit, and the connection wire group to the vehicle detection unit according to the vehicle detection signal. The server or the vehicle detection unit provides a vehicle detection report according to the plurality of vehicle status signals. The vehicle detection report at least includes the plurality of state values of the vehicle controller, the torque sensor, the motor unit, and the connection wire group.

In another aspect, the present disclosure provides a vehicle detection method. The vehicle detection method is adapted for an electric bicycle. The electric bicycle includes a vehicle controller, a torque sensor, a motor unit, a battery unit, and a connection wire group. The vehicle controller is connected to the torque sensor, the battery unit and the motor unit. The vehicle detection unit includes following steps: providing a vehicle detection unit, in which the vehicle detection unit is configured to be connected to the electric bicycle and a server; the vehicle detection unit providing a vehicle detection signal to the electric bicycle; the vehicle controller of the electric bicycle providing a plurality of state values of the vehicle controller, the torque sensor, the motor unit, the battery unit, and the connection wire group to the vehicle detection unit; and the vehicle detection unit or the server providing a vehicle detection report according to the plurality of the vehicle controller, the torque sensor, the motor unit, the battery unit, and a plurality of state values of the connection wire group.

Therefore, the cloud diagnosis service system and the vehicle detection method provided by the present disclosure can effectively and efficiently provide a cloud vehicle diagnosis service through the server and the diversified vehicle detection unit, thereby greatly reducing service costs.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an electric bicycle for a cloud diagnosis service system according to a first embodiment of the present disclosure;

FIG. 2 is a schematic view showing a communication connection between the electric bicycle and the cloud diagnosis service system according to the first embodiment of the present disclosure;

FIG. 3 is a functional block diagram of a control circuit of the electric bicycle according to the present disclosure;

FIG. 4 is a functional block diagram of a vehicle detection unit of the cloud diagnosis service system according to the first embodiment of the present disclosure;

FIG. 5 is an example of a vehicle detection report of the cloud diagnosis service system according to the first embodiment of the present disclosure;

FIG. 6A, FIG. 6B and FIG. 6C are schematic views of different types of vehicle detection units of the cloud diagnosis service system according to the first embodiment of the present disclosure; and

FIG. 7 is a flowchart of a vehicle detection method according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

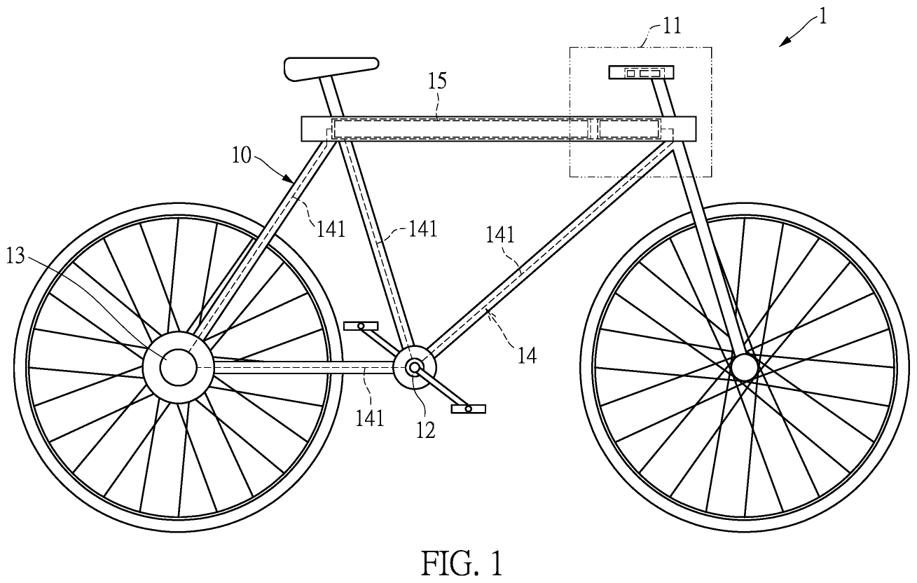

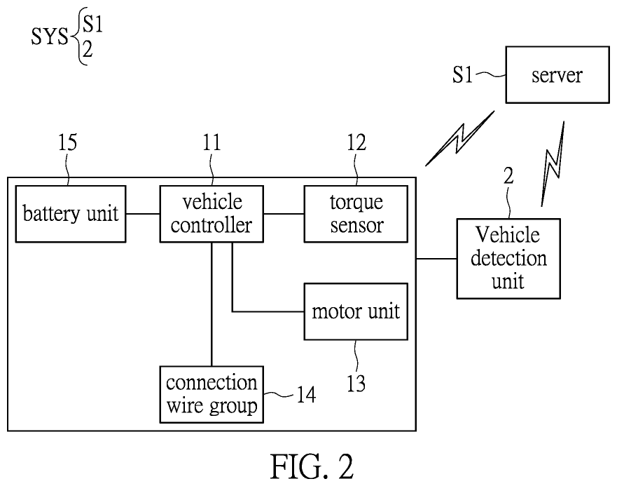

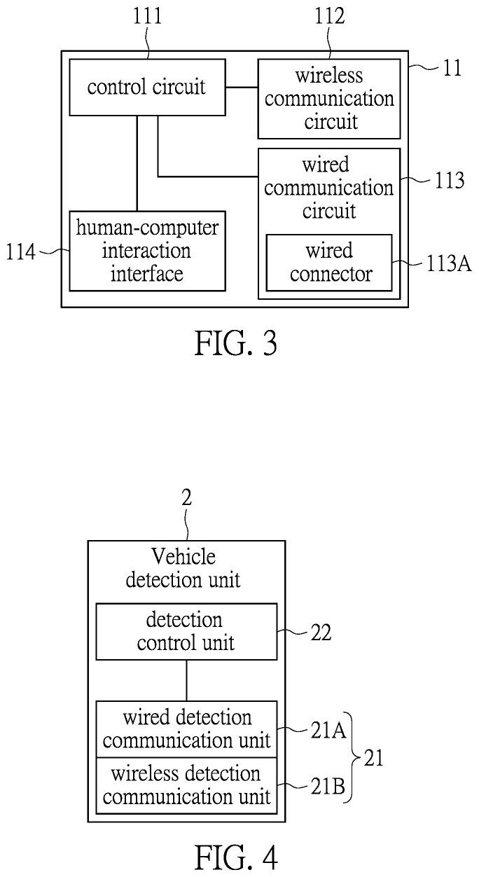

Reference is made to FIG. 1, FIG. 2, FIG. 3, and FIG. 4. FIG. 1 is a schematic view of an electric bicycle for a cloud diagnosis service system according to a first embodiment of the present disclosure. FIG. 2 is a schematic view showing a communication connection between the electric bicycle and the cloud diagnosis service system according to the first embodiment of the present disclosure. FIG. 3 is a functional block diagram of a control circuit of the electric bicycle according to the present disclosure. FIG. 4 is a functional block diagram of a vehicle detection unit of the cloud diagnosis service system according to the first embodiment of the present disclosure.

In this embodiment, a cloud diagnosis service system SYS is provided. The cloud diagnosis service system SYS of this embodiment is adapted for an electric bicycle. In other embodiments, the cloud diagnosis service system SYS may also be adapted for other types of vehicles, and are not limited in the present disclosure.

An electric bicycle 1 includes a vehicle controller 11, a torque sensor 12, a motor unit 13, a connection wire group 14 and a battery unit 15. The vehicle controller 11 is connected to the torque sensor 12, the motor unit 13 and the battery unit 15 through the connection wire group 14. In this embodiment, the electric bicycle 1 further includes a vehicle body 10.

The vehicle controller 11, the torque sensor 12, the motor unit 13, the connection wire group 14 and the battery unit 15 are disposed on the vehicle body 10.

Referring to FIG. 4, in this embodiment, the cloud diagnosis service system SYS includes a server S1 and a vehicle detection unit 2.

The vehicle detection unit 2 is connected to the electric bicycle 1 and the server S1. The vehicle detection unit 2 downloads a first detection program from the server S1, and the first detection program is installed into the vehicle detection unit 2. The vehicle detection unit 2 provides a vehicle detection signal to the vehicle controller 11 of the electric bicycle 1. The vehicle controller 11 of the electric bicycle 1 provides a plurality of current vehicle status signals of the electric bicycle 1 to the vehicle detection unit 2 according to the vehicle detection signal.

The vehicle detection unit 2 provides the plurality of vehicle status signals of the electric bicycle 1 to the server S1.

The server S1 or the vehicle detection unit 2 can provide a vehicle detection report according to the plurality of vehicle status signals. Based on the vehicle detection report, users can determine whether the situation can be handled by themselves, or that maintenance services are needed.

The plurality of vehicle status signals in the vehicle detection report include at least a plurality of state values of the vehicle controller 11, the torque sensor 12, the motor unit 13, the connection wire group 14 and the battery unit 15.

In this embodiment, the connection wire group 14 includes a plurality of connecting wire units 141, and one of the plurality of connecting wire units 141 is connected to at least another one of the plurality of connecting wire units 141, so that the torque sensor 12, the motor unit 13, and the battery unit 15 are capable of being connected to the vehicle controller 11.

The battery unit 15 is electrically connected to the motor unit 13. The battery unit 15 provides electric power to the motor unit 13.

In this embodiment, the motor unit 13 is a hub motor. In other embodiments, the motor unit 13 may be a step motor or a single-phase motor, and is not limited in the present disclosure.

The connection wire group 14 includes a power connection wire and a communication connection wire. That is, the power connection wire and the communication connection wire can be disposed separately. In this way, the vehicle controller 11 can effectively confirm a power state of each element and element operation states. In other words, the plurality of state values of the vehicle controller 11, the torque sensor 12, the motor unit 13, the connection wire group 14, and the battery unit 15 can be detected.

The state value of the connection wire group 14 further includes a connection node state of the vehicle controller 11, the torque sensor 12, the motor unit 13 and the battery unit 15 that are connected to the connection wire group 14. That is, whether or not the vehicle controller 11, the torque sensor 12, the motor unit 13 and the battery unit 15 are normally connected can also be detected by the vehicle detection unit 2.

Referring to FIG. 3, the vehicle controller 11 further includes a control circuit 111, a wireless communication circuit 112, a wired communication circuit 113, and a human-computer interaction interface 114. The control circuit 111 is electrically connected to the wireless communication circuit 112, the wired communication circuit 113 and the human-computer interaction interface 114.

The wired communication circuit 113 further includes a wired connector 113A that is electrically connected thereto.

Both of the wireless communication circuit 112 and the wired connector 113A can be used to connect the vehicle detection unit 2. That is, the vehicle detection unit 2 can be connected with the electric bicycle 1 through wired communication or wireless communication.

Referring to FIG. 4, the vehicle detection unit 2 includes a detection communication unit 21 and a detection control unit 22. The detection control unit 22 is connected to the detection communication unit 21. The detection communication unit 21 is used to connect to the server S1. The detection communication unit 21 can include a wired detection communication unit 21A and a wireless detection communication unit 21B, which are communicatively connected to the wireless communication circuit 112 or the wired communication circuit 113 of the vehicle controller 11 of the electric bicycle 1.

The control circuit 111 and the detection control unit 22 can be a central processing unit (CPU), an application-specific integrated circuit (ASIC), a graphics processing unit (GPU) or a microprocessor (MCU).

The wired detection communication unit 21A can also be independently disposed, so as to be communicatively connected with the server S1 and receive a control signal of the server S1 or data in a database of the server S1. When the detection communication unit 21 is a wireless communication unit, the detection communication unit 21 can be a WI-FI® communication unit, a BLUETOOTH® communication unit, a ZIGBEE® communication unit, a LoRa communication unit, a Sigfox communication unit or an NB-IoT communication unit.

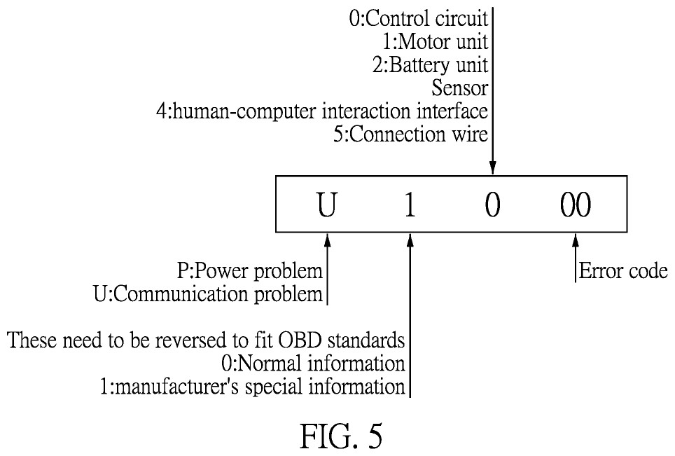

Referring to FIG. 5, FIG. 5 is an example of a vehicle detection report of the cloud diagnosis service system according to the first embodiment of the present disclosure.

In this embodiment, the vehicle detection report provided by the vehicle detection unit 2 is as shown in FIG. 5. The vehicle detection report includes at least the following types of information: (1) communication problems or power supply problems; (2) commonly-occurring information or manufacturer-specific information; (3) components to be confirmed (i.e., the vehicle controller 11, the torque sensor 12, the motor unit 13, the battery unit 15 or the connection wire group 14); and (4) an error code.

In other words, the server S1 or the vehicle detection unit 2 can diagnose a status of the electric bicycle 1 according to the plurality of state values of the vehicle controller 11, the torque sensor 12, the motor unit 13, the battery unit 15 or the connection wire group 14. When one of the components of the electric bicycle 1 (i.e., the vehicle controller 11, the torque sensor 12, the motor unit 13, the battery unit 15 or the connection wire group 14) is damaged or a riding condition is poor, detection can be carried out by the vehicle detection unit 2.

As shown in FIG. 5, types of the detected problems are listed in sequence, and whether the problem is a commonly occurring problem or a manufacturer-specific problem is determined before providing the problematic component.

The user can directly obtain the vehicle detection report through the vehicle detection unit 2. The server S1 can also be connected through the vehicle detection unit 2, so that the user can obtain further diagnostic services or other services.

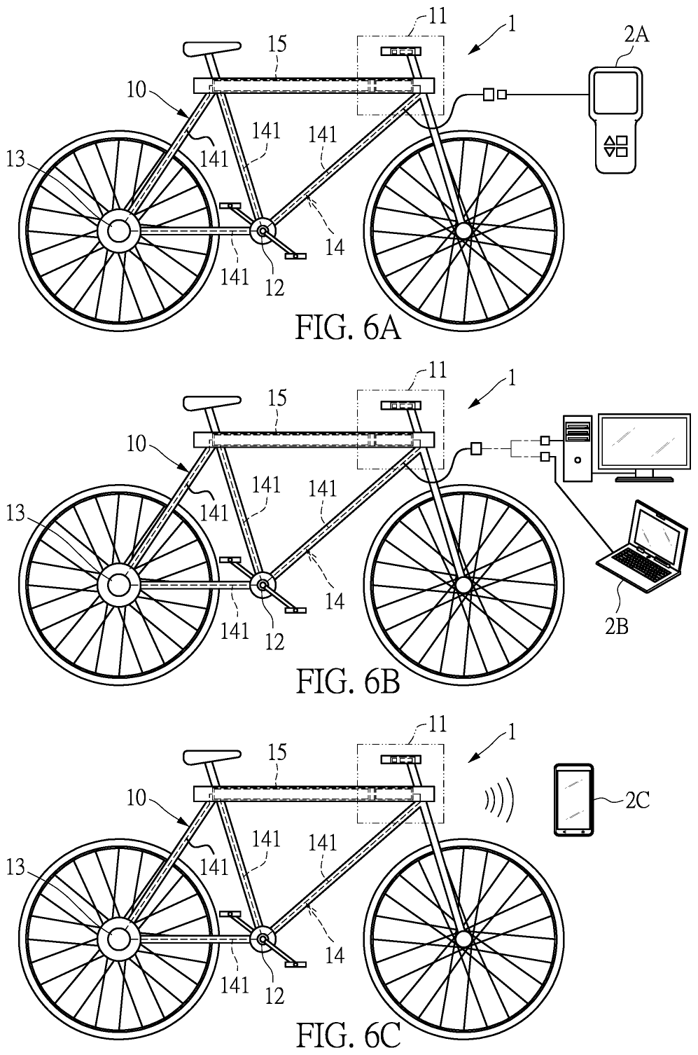

Referring to FIG. 6A, FIG. 6B, and FIG. 6C, FIG. 6A, FIG. 6B and FIG. 6C are schematic views of different types of vehicle detection units of the cloud diagnosis service system according to the first embodiment of the present disclosure.

The vehicle detection unit 2A is a general-purpose on-board automatic diagnosis device. Through an Internet network and the detection communication unit 21 of the vehicle detection unit 2A, the vehicle detection unit 2A can download the first detection program suitable for the general-purpose on-board automatic diagnosis device from the server S1 for installation. In this embodiment, the detection communication unit 21 includes an on-board automatic diagnosis connection interface (OBDII connection interface).

When the vehicle detection unit 2A has completed installation of the first detection program, the vehicle detection unit 2A can be connected to the wired connector 113A of the electric bicycle 1 through the on-board automatic diagnosis connection interface of the detection communication unit 21. In this embodiment, the wired connector 113A includes a male socket or a female socket of the on-board automatic diagnosis connection interface.

In addition, the wired connector 113A can also include other types of connectors (such as a USB connector or a Lightning connector) for connection with a mobile device. The wired connector 113A is disposed on the vehicle body 10, and is used to connect other electronic devices or the vehicle detection unit 2A.

Referring to FIG. 6B and FIG. 6C, vehicle detection units 2B and 2C can be a desktop computer, a notebook computer, a mobile electronic device or a tablet computer. In FIG. 6B, the vehicle detection unit 2B is a desktop computer. The vehicle detection unit 2C in FIG. 6C is a mobile phone.

The vehicle detection unit 2B can use the detection communication unit 21 to download the first detection program from the server S1. At this time, the above-mentioned desktop computer, notebook computer, mobile electronic device or tablet computer can be used as the vehicle detection unit 2B by cooperating with the first detection program, and can be connected with the electric bicycle 1 to diagnose a usage state of the electric bicycle 1.

The vehicle detection units 2B, 2C (e.g., a desktop computer, a notebook computer, a mobile electronic device or a tablet computer) can be connected to the electric bicycle 1 through the detection communication unit 21 (i.e., the wired detection communication unit 21A and the wireless detection communication unit 21B). Wireless detection communication units of the vehicle detection units 2B and 2C (e.g., a desktop computer, a notebook computer, a mobile electronic device or a tablet computer) include a WI-FI® communication unit, a BLUETOOTH® communication unit, a ZIGBEE® communication unit, a LoRa communication unit, a Sigfox communication unit or an NB-IoT communication unit, so as to connect the wireless communication circuit 112 of the electric bicycle 1.

In addition to downloading the first detection program from the server S1, the vehicle detection units 2B and 2C can also request advanced services (such as engineering support services or advanced diagnostic services) from the server S1 through the first detection program.

### Second Embodiment

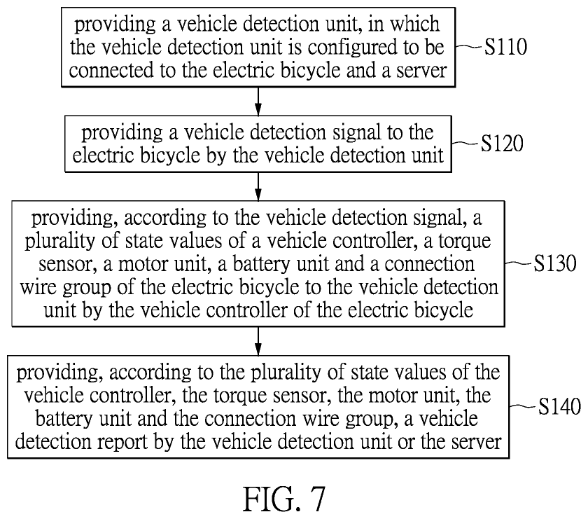

Referring to FIG. 7, FIG. 7 is a flowchart of a vehicle detection method according to a second embodiment of the present disclosure.

In this embodiment, a vehicle detection method is provided, which is adapted for the cloud diagnosis service system SYS of the first embodiment.

The vehicle detection method is applicable to an electric bicycle, and the vehicle detection method includes the following steps:

Step S110: providing a vehicle detection unit, in which the vehicle detection unit is configured to be connected to the electric bicycle and a server;

Step S120: providing a vehicle detection signal to the electric bicycle by the vehicle detection unit;

Step S130: providing, according to the vehicle detection signal, a plurality of state values of a vehicle controller, a torque sensor, a motor unit, a battery unit and a connection wire group of the electric bicycle to the vehicle detection unit by the vehicle controller of the electric bicycle; and

Step S140: providing, according to the plurality of state values of the vehicle controller, the torque sensor, the motor unit, the battery unit and the connection wire group, a vehicle detection report by the vehicle detection unit or the server.

### Beneficial Effects of the Embodiments

In conclusion, the cloud diagnosis service system and the vehicle detection method provided by the present disclosure can effectively and efficiently provide a cloud vehicle diagnosis service through the server and the diversified vehicle detection unit, thereby greatly reducing service costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A cloud diagnosis service system adapted for an electric bicycle, wherein the electric bicycle includes a vehicle controller, a torque sensor, a motor unit, a battery unit, and a connection wire group, and the vehicle controller is connected to the torque sensor, the battery unit, and the motor unit through the connection wire group, the cloud diagnosis service system comprising:
a server; and
a vehicle detection unit being connected to the electric bicycle and the server, the vehicle detection unit downloading a first detection program from the server;
wherein the vehicle detection unit provides a vehicle detection signal to the electric bicycle, the vehicle controller provides a plurality of state values of the vehicle controller, the torque sensor, the motor unit, the battery unit, and the connection wire group to the vehicle detection unit according to the vehicle detection signal;
wherein the server or the vehicle detection unit provides a vehicle detection report according to a plurality of vehicle status signals;
wherein the vehicle detection report at least includes the plurality of state values of the vehicle controller, the torque sensor, the motor unit, and the connection wire group.

2. The cloud diagnosis service system according to claim 1, wherein the vehicle detection unit provides the plurality of state values of the vehicle controller, the torque sensor, the motor unit, and the connection wire group to the server.

3. The cloud diagnosis service system according to claim 2, wherein the connection wire group includes a power connection wire and a communication connection wire.

4. The cloud diagnosis service system according to claim 3, wherein the vehicle detection unit is a general-purpose on-board automatic diagnosis device.

5. The cloud diagnosis service system according to claim 4, wherein the vehicle detection unit includes an on-board automatic diagnosis connection interface, and the vehicle detection unit is connected to the electric bicycle through the on-board automatic diagnosis connection interface.

6. The cloud diagnosis service system according to claim 3, wherein the vehicle detection unit is a desktop computer, a notebook computer, a mobile electronic device or a tablet computer.

7. The cloud diagnosis service system according to claim 6, wherein the vehicle detection unit includes a USB connector or a LIGHTNING connector, and the vehicle detection unit is connected to the electric bicycle through the USB connector or the LIGHTNING connector.

8. A vehicle detection method adapted for an electric bicycle, wherein the electric bicycle includes a vehicle controller, a torque sensor, a motor unit, a battery unit, and a connection wire group, and the vehicle controller is connected to the torque sensor, the battery unit and the motor unit through the connection wire group, the vehicle detection method comprising:
providing a vehicle detection unit, wherein the vehicle detection unit is configured to be connected to the electric bicycle and a server;
providing a vehicle detection signal to the electric bicycle by the vehicle detection unit;
providing, according to the vehicle detection signal, a plurality of state values of the vehicle controller, the torque sensor, the motor unit, the battery unit, and the connection wire group to the vehicle detection unit by the vehicle controller of the electric bicycle; and
providing, according to the plurality of state values of the vehicle controller, the torque sensor, the motor unit, the battery unit, and the connection wire group, a vehicle detection report by the vehicle detection unit or the server.

9. The vehicle detection method according to claim 8, wherein the connection wire group includes a power connection wire and a communication connection wire.

10. The vehicle detection method according to claim 8, wherein the vehicle detection unit is a general-purpose on-board automatic diagnosis device, a desktop computer, a notebook computer, a mobile electronic device or a tablet computer, and the vehicle detection unit includes an on-board automatic diagnosis connection interface, a USB connector, or a LIGHTNING connector.
